(19) United States
(12) Patent Application Publication
(10) Pub. No.: US 2026/0213029 A1
(43) Pub. Date: Jul. 23, 2026

(54) MODULAR SODIUM PRESSURE SENSOR FOR NUCLEAR REACTOR

(71) Applicant: TerraPower, LLC, Bellevue, WA (US)

(72) Inventor: Stephen Moore, Kirkland, WA (US)

(21) Appl. No.: 19/391,952

(22) Filed: Nov. 17, 2025

Related U.S. Application Data
(60) Provisional application No. 63/746,855, filed on Jan. 17, 2025.

(51) Int. Cl. G21C 17/022; G01L 9/00

(52) U.S. Cl. CPC G21C 17/022; G01L 9/0041

(57) ABSTRACT

In a sodium fast reactor, a bypass pipe is fluidly coupled to the primary sodium pump discharge and diverts a portion of the primary sodium coolant to an instrument assembly. The instrument assembly includes a bypass tank and selectively swappable instrument modules. The instrument modules can be configured to measure flow, pressure, temperature, and fluid level, among other things. A modular pressure sensor that includes a diaphragm and a transducer may be easily swappable within the bypass tank. A guard pipe may extend above the reactor vessel head and house the transducer while the diaphragm is in contact with primary sodium, the transducer being located away from the thermal and radiological environment of the primary sodium. The modular pressure sensor is pre-calibrated and is accessible from above the reactor head for quick and efficient removal and replacement of the entire pressure sensor assembly.

### GOVERNMENT LICENSE RIGHTS

This invention was made with government support under DOE Cooperative Agreement No. DE-NE0009054 awarded by the U.S. Department of Energy. The government has certain rights in the invention.

### BACKGROUND

In a sodium-cooled fast reactor (“SFR”), the reactor components include a reactor vessel filled with a liquid sodium coolant and a reactor core. In some cases, an SFR is a once-through fast reactor that runs on subcritical reload fuel that is bred up and burned in situ. The reactor core is immersed in the sodium pool in the reactor vessel. In some designs, the core may include fuel pins bundled into fuel assemblies that contain fissile fuel and fertile fuel that may be bred up into fissile fuel. The primary sodium coolant flows through the reactor core, and through the fuel assemblies and around the fuel pins, thus drawing heat away from the fuel pins. As the coolant flow upward through the reactor core, it becomes heated and continues to flow upward out of the core to a hot pool. From the hot pool, the sodium coolant enters one or more heat exchangers and flows downward to the cold pool. In many cases, the sodium not only flows by natural circulation, which is caused by the heated sodium having a lower density and thus rises from the core and displaces colder sodium, which flows downwardly toward the cold pool. However, in addition to natural circulation, forced circulation (e.g., a pump) also causes the sodium to flow from the hot pool, through the heat exchanger and back to the cold pool.

In order to measure the temperature and flow of the sodium coolant through the primary sodium pump (“PSP”), discharge PSP instruments are mounted to the discharge of the PSP. Examples of these instruments typically include thermocouples to measure temperature and bellows or diaphragm-type pressure sensors to measure pressure and flow. However, in some typical sodium fast reactors, the discharge of the PSP is located approximately 40+ feet below the reactor head, which creates many challenges in maintenance and/or replacement of failed sensor components.

While a thermocouple could potentially be routed along the internals of the PSP and replaced; however many other sensors, like the bellows-type pressure sensor could not be replaced without removal of the entire PSP.

Moreover, typical systems also require a Sodium-Potassium (NaK) capillary tube from the process connection bellows at the PSP discharge to the bellows above the reactor head, which is very difficult to fill as well as impractical to fabricate, and further, results in undesirable response times, such as on the order of thirty seconds or greater.

It would be advantageous if the temperature, pressure and/or flow could be measured by instruments that are much easier to maintain and replace without the necessity to remove the entire PSP in order to do so. Moreover, a system that allows improved response times would also provide more immediate feedback to reactor operators to ensure smooth and reliable operation of the nuclear reactor. Similarly being able to service sensors along sodium piping system without requiring the cutting of the pipe to service and/ore replace the sensors would be a significant improvement over the state of the art.

These, and other features and advantages will become apparent to those of skill in the art by reference to the following figures and description.

### SUMMARY

A system for measuring sodium in a sodium fast reactor includes a primary sodium pump configured to circulate primary sodium coolant within a reactor vessel, the primary sodium pump having a discharge; a bypass pipe fluidly coupled to the discharge at a first bypass end and having a second bypass end; a bypass tank coupled to a seal plate within the reactor, and having a second bypass tank end open above the pool of sodium and is exposed to the cover gas space; and an instrument module insertable through an aperture in the reactor head into the bypass tank and selectively coupled to the second bypass end at a coupling, the instrument module comprising one or more instruments configured to measure a characteristic of sodium within the bypass pipe. The bypass tank may additionally have holes near the first bypass tank end, such as for allowing fluid communication between the interior of the bypass tank and a primary cover gas area.

A pressure sensor assembly for measuring pressure of primary sodium coolant in a sodium fast reactor includes a sealed hollow pipe having a first end and a second end, with one or more diaphragms positioned near the second end. The diaphragms are configured to interact with sodium coolant and deform in response to fluid pressure. A transducer is positioned within the sealed hollow pipe near the first end and is coupled to the one or more diaphragms via a capillary tube that transmits pressure from the diaphragms to the transducer. A mounting flange is configured to mount the sealed hollow pipe to a reactor head of a nuclear reactor, enabling the pressure sensor assembly to be removed and replaced through the reactor head without removal of a reactor coolant pump.

In some embodiments, the mounting flange is located at the first end of the sealed hollow pipe and seals the first end. An electrical penetration may extend through the mounting flange to allow wires to extend from the transducer to a location outside the pressure sensor assembly, enabling transmission of electrical signals from the transducer to external monitoring equipment.

In various embodiments, the sealed hollow pipe is filled with insulation, radiation shielding, or a combination thereof to protect the transducer from thermal and radiological environments. The insulation may include mineral wool, ceramic fiber, or other suitable high-temperature insulation materials, while the radiation shielding may include lead, tungsten, or other suitable radiation-attenuating materials.

In some embodiments, a ring seal is provided on an outside surface of the sealed hollow pipe. The ring seal is configured to cooperate with a bypass tank located within a nuclear reactor vessel to provide a fluid-tight seal between the sealed hollow pipe and the bypass tank. The ring seal may be a metal seal, an elastomeric seal, or other suitable sealing element capable of maintaining integrity in high-temperature sodium environments.

In certain embodiments, the mounting flange is located along the sealed hollow pipe at an intermediate location between the transducer near the first end and the one or more diaphragms near the second end. This configuration allows the transducer to be positioned above the reactor head while the diaphragms remain in contact with the sodium coolant below.

In some embodiments, the one or more diaphragms comprise two diaphragms vertically stacked with flow holes positioned therebetween to allow sodium exchange. This dual-diaphragm configuration provides redundancy and allows continuous pressure monitoring even if one diaphragm experiences degradation. The flow holes enable sodium circulation to ensure accurate pressure measurement at both diaphragms.

In various embodiments, the capillary tube contains sodium-potassium (NaK) alloy as a pressure transmitting medium. The NaK alloy remains liquid at operating temperatures and efficiently transmits pressure from the diaphragms to the transducer while maintaining chemical compatibility with the sodium coolant environment.

In some embodiments, the sealed hollow pipe has a length ranging from about 0.5 meters to about 3 meters, or from about 1 meter to about 2 meters, or about 1.5 meters. The diameter of the sealed hollow pipe may range from about 1 inch (25 mm) to about 4 inches (100 mm), or from about 1.5 inches (38 mm) to about 3 inches (75 mm), or about 2 inches (50 mm). These dimensions allow the pressure sensor assembly to be manually handled during replacement operations while providing sufficient space for internal components.

According to some embodiments, a sensor system for a sodium-cooled reactor includes a bypass pipe fluidly coupled to a reactor primary sodium pump discharge. The bypass pipe diverts a portion of sodium coolant from the main flow path. A bypass tank is positioned above a reactor core and coupled to the bypass pipe. The bypass tank provides a housing for at least one instrument module that is removably positioned in the bypass tank through an aperture in a reactor head. The instrument module comprises a pressure sensor assembly including one or more diaphragms configured to interact with sodium coolant and a transducer configured to convert pressure to an electrical signal. The instrument module is accessible for maintenance or replacement operations through the reactor head, allowing service without removing the primary sodium pump.

In some embodiments, the instrument module is configured to measure one or more of pressure, temperature, and flow rate of the sodium coolant. Temperature measurements may be obtained through thermocouples or resistance temperature detectors, while flow measurements may be obtained through magnetic flow meters, differential pressure measurements, or other suitable flow sensing technologies.

In various embodiments, a mounting flange is provided for each instrument module to facilitate secured mounting and removal through the reactor head. The mounting flanges may include lifting points or attachment features for crane operations during module replacement.

In certain embodiments, the bypass tank comprises access apertures aligned with corresponding reactor head openings to facilitate direct access to instrument modules. Multiple apertures may be provided to allow installation of different types of instrument modules simultaneously.

In some embodiments, the bypass pipe is configured to divert less than 5% of total flow from the reactor primary sodium pump discharge, or less than 3%, or less than 2%, or between about 0.5% and 2%. This limited diversion ensures minimal impact on core cooling while providing sufficient flow for accurate measurements.

In various embodiments, the instrument module comprises a flow module bypass configured to receive sodium from the bypass pipe, a boundary plate separating a wetted lower section from a dry upper section of the instrument module, and one or more annular flow restriction plates configured to control pressure drop through the instrument module. The boundary plate prevents sodium from entering the upper dry section while allowing pressure transmission through sealed penetrations.

In some embodiments, a thermowell extends from an upper portion of the instrument module to the boundary plate. The thermowell is configured to house temperature measurement devices for determining sodium temperature at the boundary plate, which corresponds to the temperature of sodium flowing through the instrument module.

According to some embodiments, a modular pressure sensor configured for use within a sodium-cooled reactor includes a pressure assembly having one or more diaphragms configured to contact sodium coolant. A capillary tube transmits pressure from the one or more diaphragms to a transducer that converts the pressure transmitted through the capillary tube into an electrical signal. A guard pipe extends above a reactor vessel head and is configured to house the transducer outside of the thermal and radiological environment of the sodium coolant. A flange enables replacement of the pressure assembly through a reactor head.

In some embodiments, the guard pipe is configured to house additional instrumentation for leak detection in its sealed space. Leak detection sensors may include conductivity sensors, moisture sensors, or gas detection sensors configured to identify sodium vapor or aerosols.

In various embodiments, a removable cover plate is attached to the guard pipe permitting maintenance and inspection of the sensor. The cover plate may include electrical penetrations for signal transmission and may be sealed to maintain the integrity of the guard pipe interior.

In certain embodiments, the flange is positioned to align with existing reactor head structures, facilitating quick detachment and reattachment during replacement procedures. The alignment features may include guide pins, keyways, or other positioning elements that ensure proper orientation during installation.

In some embodiments, the pressure sensor assembly is configured to measure sodium pressure at reactor power levels ranging from 5% to 100% of full power. The wide operational range enables continuous monitoring during startup, shutdown, and steady-state operation.

In various embodiments, the pressure sensor assembly comprises a first pressure sensor configured for low-range pressure measurements at reactor power up to a threshold power level and a second pressure sensor configured for high-range pressure measurements at reactor power greater than the threshold power level. In some cases, the threshold power level is 5%, or 10%, or 15%, or 20%, or 25%, or 30%. The dual-sensor configuration provides optimal accuracy across the entire operational envelope.

In some embodiments, the instrument module has a height of less than 15 feet, or less than 12 feet, or less than 10 feet, and is positioned entirely within an upper half of a reactor vessel. This positioning reduces the radiation exposure and temperature experienced by the instruments while maintaining accessibility from the reactor head.

In certain embodiments, the at least one instrument module comprises a slip-on coupling configured to form a removable fluid-tight seal with the bypass pipe. The slip-on coupling may include annular ridges, sealing surfaces, or compressible elements that create a metal-to-metal or elastomeric seal upon installation.

In various embodiments, the bypass tank is positioned within a primary sodium pump tank, allowing the instrument modules to be accessed through penetrations in the pump tank flange while minimizing the required reactor vessel penetrations.

In some embodiments, the guard pipe comprises a sealed interior space, thermal insulation surrounding at least a portion of the transducer, and radiation shielding positioned between the one or more diaphragms and the transducer. The combination of thermal insulation and radiation shielding extends the operational life of the transducer and maintains measurement accuracy.

According to some embodiments, a pressure sensor assembly is provided for measuring pressure of coolant in a reactor, which includes a hollow pipe having a first end and a second end; at least one pressure-responsive element near the second end; at least one signal conversion element coupled to the at least one pressure-responsive element; and a mounting structure configured to couple the hollow pipe to a reactor structure. The pressure-responsive element 1012 can comprise a bellows assembly which may be formed of AM350 stainless steel, Inconel 718, and/or Inconel X-750. The bellows assembly can have a convolution count ranging from 5 to 50, or from 10 to 30, or about 20 convolutions. The bellows assembly can have an effective diameter ranging from about 10 mm to about 100 mm, or from about 20 mm to about 60 mm, or about 40 mm. The bellows assembly can be configured as an edge-welded bellows, a formed bellows, and/or an electroformed bellows.

The described embodiments enable efficient maintenance and replacement of pressure sensing equipment in sodium-cooled reactors while maintaining accurate measurements across all operational conditions. The modular design allows pre-calibrated sensor assemblies to be quickly exchanged during scheduled maintenance periods without requiring pump removal or extensive system modifications.

### BRIEF DESCRIPTION OF THE DRAWINGS

The accompanying drawings are part of the disclosure and are incorporated into the present specification. The drawings illustrate examples of embodiments of the disclosure and, in conjunction with the description and claims, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

The following drawing figures, which form a part of this application, are illustrative of described technology and are not meant to limit the scope of the technology as claimed in any manner, which scope shall be based on the claims appended hereto.

FIG. 1 illustrates a partial cutaway perspective view of a nuclear fission reactor, in accordance with some embodiments.

FIG. 2 is a cutaway view of a primary sodium pump, bypass, and bypass tank, in accordance with some embodiments.

FIG. 3 is a schematic illustration of a PSP instrument module showing discharge instruments, in accordance with some embodiments.

FIG. 4 is a perspective view of a PSP instrument module showing a flow measurement module.

FIG. 5 is a partial cutaway view showing the coupling and seal between an instrument module and a bypass pipe.

FIG. 6 is a schematic illustration of a PSP instrument module showing discharge instruments, including a level sensing manifold, in accordance with some embodiments.

FIG. 7 is a schematic illustration of a PSP instrument module, including a low range pressure assembly and a high range pressure assembly, in accordance with some embodiments.

FIG. 8 is a schematic illustration of a PSP instrument module showing discharge instruments and a bypass pipe disposed inside the PSP tank, in accordance with some embodiments.

FIG. 9 is a schematic illustration of a PSP instrument module that can be primed and wetted with sodium to create a siphon to maintain the sodium level, in accordance with some embodiments.

FIG. 10 illustrates a pressure sensor assembly, in accordance with some embodiments.

FIG. 11 illustrates an installed pressure sensor assembly into the cooperating structures and system, in accordance with some embodiments.

FIG. 12 illustrates a cutaway view of the components shown in FIG. 11, in accordance with some embodiments.

FIG. 13 is a cutaway close-up view of the upper end of the flow module, pressure sensor assembly, and reactor head nozzle, in accordance with some embodiments.

FIG. 14 illustrates a close-up cutaway view the lower end of the pressure sensor assembly, in accordance with some embodiments.

FIG. 15 illustrates an embodiment of a pressure sensor assembly with a guard pipe, in accordance with some embodiments.

FIG. 16 illustrates another embodiment of a pressure sensor assembly, in accordance with some embodiments.

FIG. 17 illustrates a pressure sensor assembly installed into a fluid loop, in accordance with some embodiments.

FIG. 18 illustrates an embodiment of a pressure sensor assembly inserted into a pipe standoff that incorporates a guard pipe, in accordance with some embodiments.

### DETAILED DESCRIPTION

The disclosure sets forth example embodiments and, as such, is not intended to limit the scope of embodiments of the disclosure and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

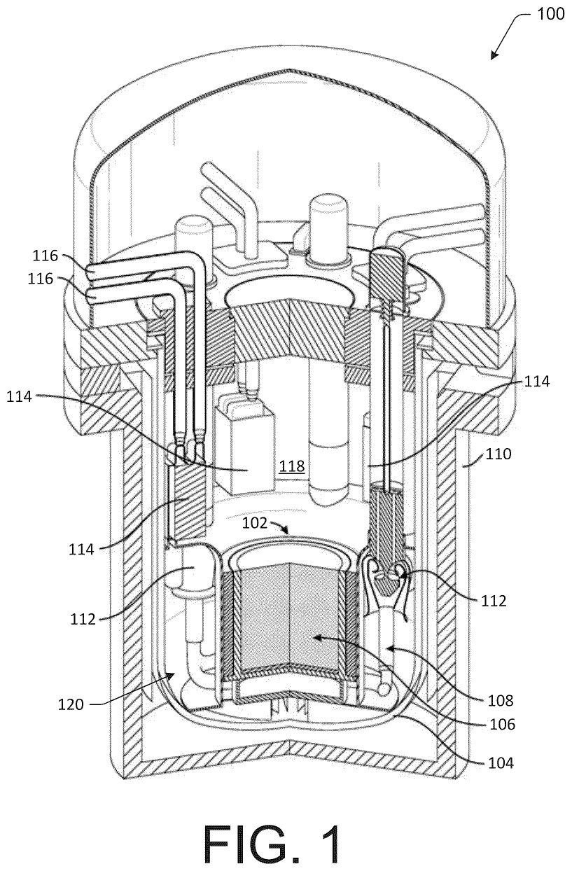

FIG. 1 illustrates a fission reactor and reactor core as a non-limiting overview and not by way of limitation. As shown, nuclear fission reactor 100 includes a nuclear fission reactor core 102 disposed in a reactor vessel 104. According to some embodiments, nuclear fission reactor core 102 contains nuclear fuel within a central core region 106. Nuclear fission reactor core 102 may include fuel assemblies, and reactivity control assemblies. According to some embodiments, an in-vessel handling system (not shown) is configured to shuffle ones of the nuclear fuel assemblies. Nuclear fission reactor 100 may also include a reactor coolant system 108.

In some implementations, the nuclear fission reactor 100 is based on elements of liquid metal-cooled, fast reactor technology. For example, in various embodiments the reactor coolant system 108 includes a pool of liquid sodium disposed in the reactor vessel 104. In such cases, the nuclear fission reactor core 102 is submerged in the pool of sodium coolant in the reactor vessel 104. The reactor vessel 104 may be surrounded by a containment vessel 110 that helps prevent loss of sodium coolant in the unlikely case of a leak from the reactor vessel 104.

In various embodiments, the reactor coolant system 108 includes a reactor coolant pump, such as a primary sodium pump (PSP) 112. The reactor coolant system 108 may include one pump, two pumps, or any suitable number of PSPs 112. In addition, the pumps may be any suitable pump as desired (e.g., mechanical, electromechanical, electromagnetic, induction, etc.).

The reactor coolant system 108 may include one or more heat exchangers 114. Heat exchangers 114 may be disposed in the pool of liquid sodium and may draw in heated liquid sodium into a first side of the heat exchanger 114. In some embodiments, heat exchangers 114 have non-radioactive intermediate coolant on the other side of heat exchangers 114. The intermediate coolant may be sodium, or some other working fluid. To that end, heat exchangers 114 may be considered intermediate heat exchangers.

The PSP 112 may be configured to circulate primary sodium coolant through the nuclear fission reactor core 102. In some embodiments, the pumped primary sodium coolant exits the nuclear fission reactor core 102 at a top of the nuclear fission reactor core 102 into a hot pool 118 and passes through one side of the heat exchangers 114. In some embodiments, a second working fluid is circulated via an intermediate coolant loop 116 outside the containment vessel 110, such as to a steam generator, to a thermal storage system, or may be circulated to heat exchangers for still another use. The intermediate coolant may be any suitable coolant, such as sodium, salt, or another working fluid and may include a phase change medium. After passing through the heat exchangers 114, the primary sodium returns to a lower end of the containment vessel, to a cold pool 120 where it may be drawn back through the reactor core 102 to complete the primary coolant loop.

In some cases, the primary coolant loop uses forced circulation, such as by one or more pumps, and may also use natural circulation due to the density difference of the heated and cooled sodium.

One of the difficulties in managing and operating a sodium-cooled fast reactor (“SFR”) is the instrumentation required to accurately measure volumetric flow and temperature of the sodium through the PSP 112. Historically, methods for measuring temperature and flow used discharge PSP instruments mounted to the outlet of the PSP, such as thermocouples and bellows-type sensors, which were mounted directly to the discharge of the PSP. However, the bellows to the discharge pump is not serviceable or replaceable without removing the entire PSP from the reactor vessel. Typically, in some large pool type SFRs, the PSP discharge is located in excess of 40 feet below the reactor head and submerged in radioactive sodium coolant.

Furthermore, the measurement of primary sodium flow from typical SFR PSPs relies on pump discharge pressure, which may have a full-scale error of 0.5% or more, which can result in an unacceptable error, particularly when measuring low flows due, in part, to the system curve in which pressure is exponential to flow rate.

According to the described embodiments, a system is described that allows accurate measurements, even at low flow rates, positions the PSP sensors much closer to the reactor head, and is easily serviceable and replaceable without removing the PSP from the reactor vessel. According to some embodiments, a bypass pipe is attached to the discharge of the PSP and routes some of the PSP discharge flow upward to the cold pool into a bypass tank where instruments are located.

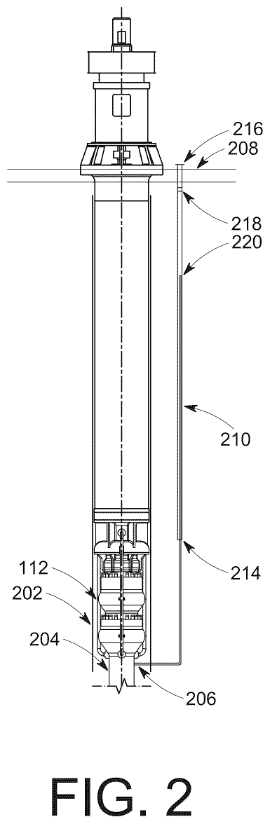

FIG. 2 illustrates a cutaway view of a primary sodium pump and a bypass tank. The PSP 112 may be positioned within a PSP tank 202. The PSP tank may be a conduit that is open at the bottom to the cold pool and encloses the PSP 112. The pump tank 202 may additionally have one or more openings at an upper end, which may be located above the level of the sodium to allow access to the cover space within the reactor vessel. The PSP 112 may be in fluid communication with one or more heat exchangers and may pull fluid from the hot pool and through the heat exchanger. The PSP discharge 204 is located at the lower end of the PSP 112 and is configured to output cooled sodium to the reactor core. In some cases, the PSP discharge 204 includes conduits that route the discharged sodium to the inlet plenum below the reactor core.

According to some embodiments, a bypass pipe 206 is coupled to the PSP discharge 204 and directs some of the sodium from the PSP discharge 204 through the bypass pipe 206. The bypass pipe 206 may extend upwardly toward the reactor head 208. In some cases, the bypass pipe 206 may enter a bypass tank 210. The bypass tank 210 may be a pipe, tube, conduit, or other such structure that allows an instrument assembly to be inserted therein. As used herein, the terms “instrument module” and “instrument assembly” are used interchangeably and refer to one or more instruments that may be selectively inserted into the bypass tank through the reactor head. The instrument module may be inserted or removed from the reactor vessel as a module and all the installed instruments may be inserted or removed together. The bypass tank may have a lower end 214 that is open to the sodium pool. In some cases, the bypass tank 210 allows sodium from within the bypass tank 210 to drain downwardly back into the sodium pool.

The bypass tank may further extend through the reactor head 208 and may include a flange 216 that allows the bypass tank 210 to be mounted to the reactor head 208 and/or gripped for withdrawal of the bypass tank 210 from the reactor vessel. In some cases, the bypass tank may be disposed entirely within the reactor vessel, and the module insert may be inserted through the reactor head and connected to the reactor head nozzle. The bypass tank 210 may further include one or more apertures 218 that allow any gas within the bypass tank to escape into the cover gas area above the sodium pool.

The bypass pipe 206 has a first end that is connected to the PSP discharge 204 and a second end that is disposed within the bypass tank. The second end may include a seal 220 that engages with the instrument assembly and may provide a fluid tight seal between the bypass pipe and the instrument assembly. The seal 220 may be any suitable seal, and may include a gasket, washer, compressible seal, O-ring, or other suitable type of seal.

In some cases, the bypass tank lower end 214 terminates below the sodium level within the reactor vessel and the instrument module terminates below the sodium level in the bypass tank. In some cases, this creates a siphon, such that by slowly ramping up the pump the bypass pipe and bypass tank are primed with sodium, which wets the pressure connection. Once the bypass pipe 206 and bypass tank are primed, the pump keeps the bypass filled by virtue of its normal operation. However, at low flows, such as below about 20%, the level in the bypass module would have a tendency to fall; however, the siphon effect would maintain an appropriate sodium level within the bypass pipe. In these examples, the sodium level within the bypass pipe is always maintained, and separate level measuring instruments may not be required, as the sodium level in the bypass pipe can be determined based on readings from the pressure instruments.

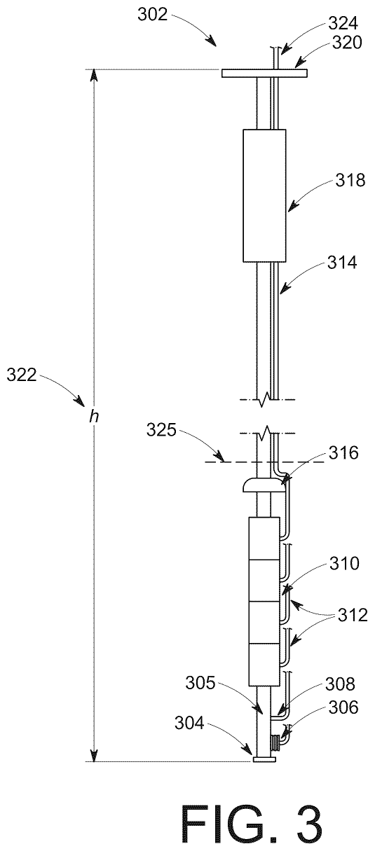

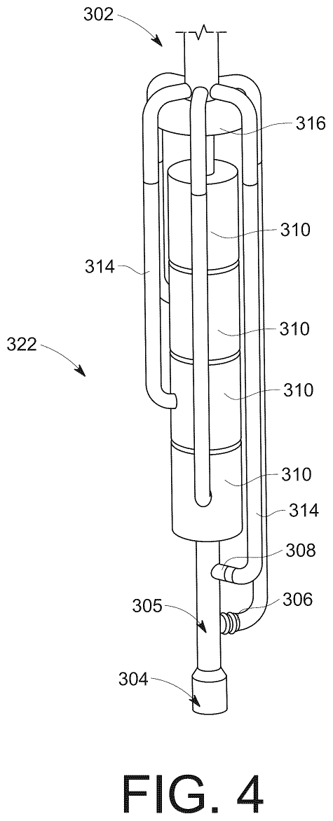

With additional reference to FIGS. 3 and 4, the instrument assembly 302 may be inserted into the bypass tank 210 and may be configured for flow measurement. The instrument assembly 302 may include a coupling 304 at a lower end which may be configured for connecting with the bypass pipe 206 second end to form a fluid tight seal therewith. In some cases, the instrument assembly includes a modular bypass pipe 305 that provides a conduit for sodium to flow therethrough. The modular bypass pipe 305 may connect to the bypass pipe 206 (which in some cases, is permanently mounted to the PSP) with a push-on seal, thus allowing a fluid tight, selectively removable, connection with the bypass pipe, which may be permanently installed within the reactor vessel.

According to some embodiments, one or more sensors may be disposed along the length of the instrument assembly 302 for detecting, measuring, and determining data regarding the sodium exiting the PSP. For example, one or more pressure sensors 306 may be included for measuring the pressure of the sodium flowing within the modular bypass pipe 305, which may then be correlated with flow rate. The instrument assembly 302 may be partially, or entirely, submerged in sodium. This is at least in part due to the bypass tank being open to the cold sodium pool and the sodium level is allowed to enter the bypass tank.

One or more thermocouples 308 may similarly be disposed along the instrument assembly 302. In use, the thermocouples 308 and pressure sensors 306 are configured to measure the discharge temperature and pressure of the PSP. The pressure measurement may be corrected for the static head difference between the location of the pressure sensor 306 and the bypass connection with the PSP discharge.

Additional instruments, such as one or more flowmeters 310, and other instruments e may be selectively placed along the instrument assembly 302 to obtain other measurements, as desired, and additional instrument conduits 314 may be provided that allow access to the instrument assembly for selectively attaching other instruments.

A bypass elbow 316 may be disposed along the instrument assembly 302, and may be located above the instruments, and can be configured to discharge flowing sodium from flowing upwardly through the instrument assembly 302 to the bypass tank. Once discharged to the bypass tank, the sodium is free to enter the sodium pool. In some cases, the bypass elbow 316 is an annular shape and may seal the instrument assembly against the inner surface of the bypass tank. Above the bypass elbow 316, support piping may provide structural support and shielding 318 may be provided near the reactor head. In some cases, the bypass elbow 316 is configured to not seal against the inner surface of the bypass tank which may allow fluid communication with the cover gas in the bypass tank. In some cases, the bypass discharge is located below the lowest cold pool level 325. In this case, the instruments can be disposed higher up on the module and once the bypass pipe is primed with sodium, the sodium level can be measured by pressure and/or temperature.

A PSP discharge instruments flange 320 may be disposed at an upper end of the instrument assembly 302 and provide a mount for securing the instrument assembly to the reactor head and/or to the bypass tank. In some examples, the PSP discharge instruments flange 320 is positioned above the reactor head and thus allows access to the instrument assembly 302 from above the reactor vessel. In some cases, the instrument assembly 302 can be removed from the reactor vessel by disconnecting the PSP discharge instruments flange 320 and withdrawing the instrument assembly 302 from the bypass tank, such as with an overhead crane. In this way, the instrument assembly 302 can be withdrawn from the reactor vessel, such as for maintenance, for replacement, or otherwise.

In some cases, the instrument assembly 302 has a height h 322. In some cases, the height h 322 is significantly smaller than a height of the PSP. With other reactor designs, the instruments are typically located at the discharge of the PSP, which can be on the order of 40 feet (12 m) or more below the reactor head. In some embodiments, the height h 322, and thus the maximum distance the instruments are located below the reactor head, is about 20 feet (6 m), or 18 feet (5.5 m), or 15 feet (4.5 m), or 13 feet (4 m), or 10 feet (3 m) or less. In this way, the instrument assembly 302 is much easier to access and maintain, which can be done without removing the PSP from the reactor vessel. Furthermore, the cabling for the instruments assembly 302 is also much shorter. The cabling may exit the reactor vessel through the reactor head by an instrument conduits out aperture 324 that provides a passageway for the instrumentation cabling to be routed out of the reactor vessel.

In some embodiments, an instrument assembly 302 could be configured to measure the bypass flow using magnetic flowmeters. The bypass elbow 316 may be located below the sodium level in the bypass tank, so that as the pump begins operation bypass flow will be detectable from the flowmeters, even at low flow rates, and maintain a siphon. In some cases, the bypass elbow 316 may be located above the sodium level; and the bypass elbow 316 may be configured to discharge below the sodium level so that the bypass can be primed and maintain a siphon within the bypass pipe to keep the sodium at an acceptable level within the bypass pipe.

The flow meters may include a sealed permanent magnet, a thermocouple attached to the magnet, and electrodes attached to the pipe. When the system is utilized in a SFR, the flowing sodium produces a voltage in the magnetic field that is proportional to its velocity. In some cases, a single instrument conduit 314 may be provided for each magnetic flow meter. Similarly, a single instrument conduit may be provided for each pressure sensor, and likewise, for each thermocouple. In some cases, the flow through the bypass pipe may be used to calculate primary sodium flow for all flow regimes, and the pressure instruments may supplement the flow data from the flow meters, especially at higher range flow regimes. In some cases, Eddy current flow meters may be used in addition to, or alternative to, magnetic flow sensors.

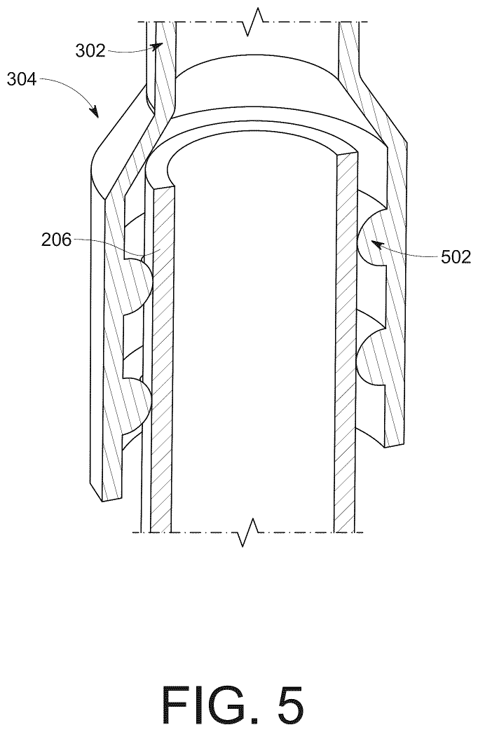

FIG. 5 illustrates details of one embodiment of a push on coupling 304 between the instrument assembly 302 and the bypass pipe 206. The coupling 304 may include one or more annular ridges 502 that contact the bypass pipe 206 and create a seal therewith. In some cases, the seal is fluid-tight such that the flow from the bypass pipe 206 is forced through the instrument assembly 302 and the instruments attached thereto. The seal may be a metal-on-metal seal and in some cases, is integrally formed with the components. In some cases, the ridges 502 may be formed on the outer surface of the bypass pipe 206, while in other cases, may be formed on the inner surface of the coupling 304. The ridges 502 may alternatively be a separate component that is attached to one of the instrument assembly 302 or the bypass pipe 206. In some cases, the ridges 502 may be formed of a different material than the instrument assembly 302 or the bypass pipe 206, and in some cases, may be formed of a material that has a higher lubricity than the instrument assembly 302 or the bypass pipe 206 material and may provide a reduced friction as the coupling 304 engages the bypass pipe 206. It should be apparent that, while the description describes the instrument module fitting over the bypass pipe, the configuration could be the opposite. That is, the instrument module could be configured to fit inside the bypass pipe while still realizing the same benefits the described configurations.

According to some embodiments, the instrument assembly 302 may be a module configured for flow measurement. The differential head from the discharge of the PSP through the bypass to the sodium surface in the bypass tank and from the discharge of the PSP through the core to the surface of the hot pool may be assumed to be the same. Through testing the bypass assembly for flow and differential pressure, the equivalent differential pressure through the core for a measured flow can be determined. The core assembly can be tested, and the differential pressure can be correlated to a flow rate. In some cases, this allows for direct measurement of bypass flow, which may result in higher accuracy than simply measuring sodium level or pressure and correlating these measurements to flow rates.

In some embodiments, a pump curve is used to correlate actual flow. For example, the differential head or pressure of the pump at the pump tank inlet level versus the PSP discharge level (e.g., for low flows) or at the PSP discharge pressure (e.g., for high flows). Using the pump curve in combination with these measurements can be used to determine an accurate flow rate. In addition, over time, as the pumps age the pump curve may change its accuracy. In some cases, the pump curve may be updated such as by comparing the pump curve to a test pump or performing calorimetric calculations with the intermediate heat exchanger and intermediate sodium flowmeters and/or thermocouples. In other words, the flow rate may be determined based, at least in part, on the pump curve. As used herein, a pump curve is a graph that plots flow vs head pressure. The curve typically begins at zero flow and static head pressure and descends until it reaches the pump runout or maximum flow rate. By utilizing the pump curve and measuring the head pressure differential, a flow rate may be determined and used with embodiments described herein.

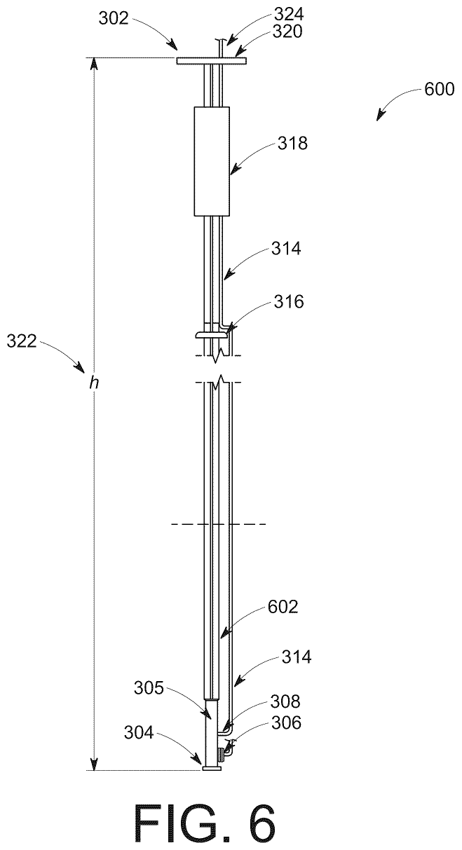

FIG. 6 illustrates an instrument assembly 302 configured for primary sodium coolant level measurements. According to some embodiments, the instrument assembly 302 is modular and different modules can be swapped out depending on the types of measurements that are desired. As illustrated, a level sensing module 600 can be inserted into the instrument assembly 302. In some cases, multiple modules can be installed simultaneously by locating multiple instrument assemblies 302 at different bypass tanks installed within the reactor vessel. Of course, additional bypass pipes may also be installed to provide additional locations for the instrument assembly modules to be located throughout the reactor. The instrument assembly 302 may have a connection seal 304 at a lower end which may be configured to engage with an upper end of the bypass pipe to allow fluid communication from the bypass pipe to the instrument assembly 302. In some cases, one or more pressure transducers 306 are provided to measure a primary sodium coolant pressure coming from the PSP. In addition, one or more temperature sensors 308 (e.g., thermocouples) may be provided to measure the temperature of the sodium as it is discharged from the PSP. Each of these sensors may have an instrument conduit 314 that extends to a location above the reactor head. In some cases, each measurement sensors has its own unique instrument conduit, although in some cases, more than one instrument may share an instrument conduit for cabling runs.

A level sensing manifold 602 may be configured to determine the level of the sodium pool within the reactor vessel. For example, the bypass pipe may be bifurcated into multiple level sensing pipes. The bypass elbow 316 may have level detection ducting attached through it which may be from above the reactor head, through which level detecting sensors may be routed. In some cases, the level detecting sensors may be any suitable level detector, such as, without limitation, radar level detectors, inductive probes, load cells, radio frequency capacitive level transmitters, ultrasonic level transmitters, float level sensors, among others.

In use, without the PSP operating, the level sensing manifold 602 may be partially submerged in the sodium pool, which would indicate the cold pool level. As the pump begins operation, the level in the level sensing manifold 602 would raise. Small changes in primary sodium flow will result in measurable changes of level (e.g., a 1% change in overall primary flow 5-15% may result in about 2 in. to 6 in. of sodium level rise in the level sensing manifold 602). The level, along with other reactor instrumentation signals (e.g., sodium temperature to determine sodium densities throughout the reactor, hot pool level to allow differential head calculation of the reactor core), would allow for accurate primary flow measurements even in a low-flow regime. The described embodiments may additionally provide a loss of flow signal for the pumps at low flow regimes. Once the primary sodium flow reaches a certain point, the sodium may overflow from the bypass pipe and into the bypass tank, and level measurement may no longer be possible, and other instrumentation may be relied upon, such as discharge PSP pressure, for example, to determine primary sodium flow.

The instrument assembly 302, as with other embodiments, may have a height h 322, that may be shorter than the height of the reactor vessel and may be shorter than the length of the PSP. In some cases, the height of the instrument assembly 302 is less than 50% of the height of the reactor vessel, or less than 40%, or less than 30%, or less than 20%, or less than 10%, or less than 5% of the height of the reactor vessel. In some cases, this places the entire instrument assembly within the upper half, or upper third, or upper quarter of the reactor vessel. By disposing the instrument assembly 302 nearer the reactor vessel head than typical reactor configurations, maintenance on the instrument assembly 302 is much more efficient. Furthermore, feedback from the instrument assembly is quicker and allows an automated system and/or an operator to take action more quickly to ensure a smooth and efficient running reactor.

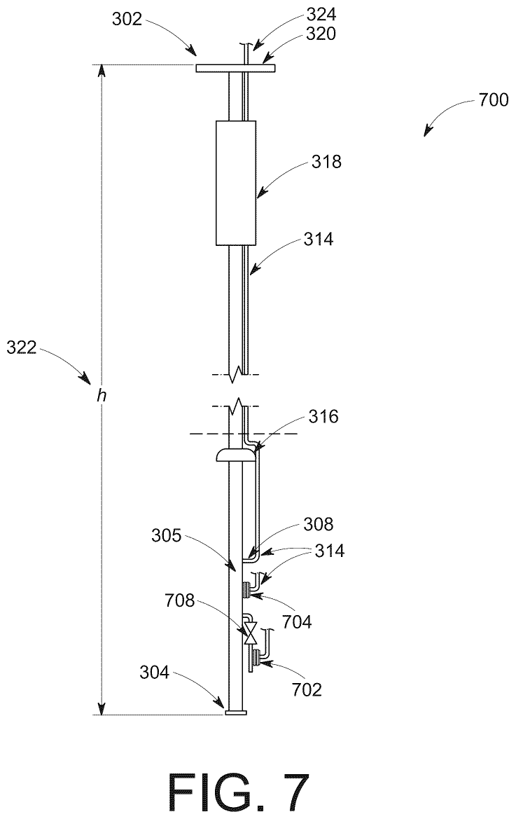

FIG. 7 illustrates another embodiment of an instrument assembly 302 that utilizes an instrument module configured as a pressure module 700. The pressure module 700 may share many components of other embodiments, such as the instrument assembly connection 304 that allows a fluid connection to the bypass pipe from the PSP discharge. A bypass elbow 316 may direct flowing sodium discharged from the instrument assembly 302 back to the bypass tank and the sodium pool. One or more instrument conduits 314 may provide a cable run for connecting instruments to a location above the vessel head through the instrument conduits out aperture 324.

A low range pressure assembly 702 may be provided to determine accurate pressure, even in a low-pressure operating state. In some cases, the instrument assembly 302 up to and including the bypass elbow 316 may be submerged in the sodium pool. A plurality of pressure sensors may be used, such as one or more high range pressure sensors 704 (e.g., for 20%-100% flow) and another one or more low range pressure sensors 702 (e.g., 5%-20% flow). In some cases, the low range pressure sensors 702 will have significantly better accuracy at low flow rates. The low range pressure sensors 702 may include an isolation valve 708 which can be configured to shut off and separate the low range pressure sensors 702 during higher power and higher flow rates. The isolation valve 708 may be electrically actuated, or in some cases may be pressure actuated such that higher flows automatically actuate the isolation valves 708 to bypass the low range pressure sensors 702 and utilize the high range pressure sensors in response to the high flow range. In some cases, the low range pressure sensors 702 may be more delicate, thus providing the ability to isolate the low range pressure sensors 702 protects the instruments while allowing accurate measurements at low flow rates.

While the illustrated and described embodiments show that the bypass tank is located external to the PSP, in some embodiments, the bypass tank may be positioned within the PSP and therefore, the instrument assemblies can be located within the bypass tank that is inside the PSP. The bypass pipe may still receive flow from the discharge of the PSP, and route that flow through the instrument assemblies that are located inside the PSP in order to determine measurements without occupying space outside the PSP.

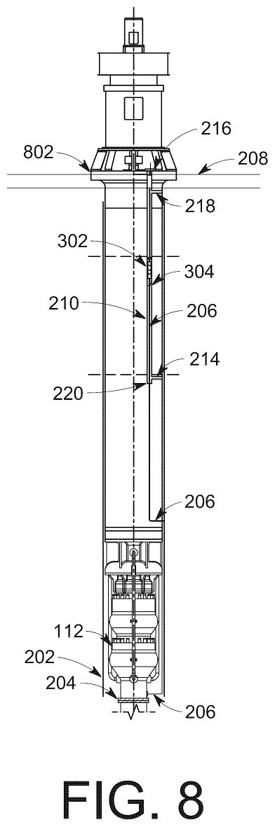

For example, as illustrated in FIG. 8, according to some embodiments, the bypass tank 210 may be disposed inside the primary sodium pump tank 202. In some cases, the bypass tank 210 may be inserted through an aperture formed in the PSP flange 802 and thereby be inserted inside the PSP bypass tank 202. An internal bypass 206 may extend from the PSP discharge upwardly while remaining inside the PSP tank 202 where it may couple to the instrument module connection 304, as described herein.

As shown in the illustrated embodiment, the instrument module 302 is disposed inside the PSP tank 202, yet can be accessed from above the reactor head 208 such as for servicing, swapping instrument modules 302, or replacing components. The instrument module 302 can be withdrawn, such as by a crane, by lifting the instrument module 302 out of the PSP tank 202. Any suitable module can be inserted in the illustrated location, and various instrument modules 302 may be inserted for multiple purposes. In some cases, a plurality of instrument modules may be installed into the PSP tank 202 simultaneously, such as by providing multiple apertures in the PSP flange 802 configured to accept instrument modules 302.

In alternative arrangements, the bypass pipe 206 may extend beyond the reactor head 208 to a location above the reactor head 208 and the instrument module 302 may be located on top of the PSP flange 802. In this example, the instrument module is disposed outside of the reactor vessel, which makes accessing the instrument module, such as for repair, replacement, swapping instruments efficient.

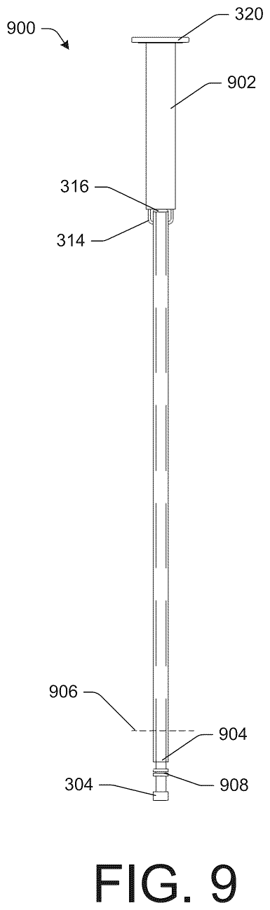

FIG. 9 illustrates another embodiment of an instrumentation module 900 that relies on priming with sodium. The instrumentation module 900 may share many components with other embodiments, such as the instrument assembly connection 304 that allows a fluid connection to the bypass pipe from the PSP discharge. A bypass elbow 316 may direct flowing sodium discharged from the instrumentation module 900 back to the bypass tank and the sodium pool. One or more instrument conduits 314 may provide a cable run for connecting instruments to a location above the vessel head through the instrument conduits out aperture.

PSP discharge instruments flange 320 may be disposed at an upper end of the instrumentation module 900 and provide a mount for securing the instrumentation module 900 to the reactor head and/or to the bypass tank. In some examples, the PSP discharge instruments flange 320 is positioned above the reactor head and thus allows access to the instrumentation module 900 from above the reactor vessel.

A drywell shielding 902 may provide a sealed pipe, which may be similar to other reactor instrumentation drywells. In some cases one or more penetrations in the drywell shielding for conduits and/or pressure transmitting capillary lines. In some cases, one or more pressure transmitters, temperature transmitters, and other transmitters may be located within the drywell shielding.

As shown, the bypass elbow 316 and instrumentation is located nearer the reactor head when compared with some other embodiments. For instance, where the instrumentation module 900 has an upper half and a lower half, the instrumentation may be positioned in the upper half of the instrumentation module 900. In some cases, locating the instruments closer to the reactor head is an area within the reactor vessel having a lower temperature than locating the instruments lower in the reactor vessel closer to the reactor core in a bottom portion of the reactor vessel. This location may also reduce the required length for some of the instruments, such as the capillary tube on the pressure instruments.

The bypass pipe may include an inner pipe surrounded by an annular return pipe which may be sealed to the bypass elbow 316. The discharge 904 to the bypass tank is located below a sodium level 906 in the bypass tank. Connections of the temperature and/or pressure instruments may be connected to the inner or outer piping of the bypass pipe. During initial startup of the PSP, slowly ramping up the PSP flow rate would fully wet the bypass and create a siphon within the bypass pipe that will draw sodium into the bypass and even after ramping down the PSP, the bypass would remain filled with sodium due to the sealed connections and sealed space within the bypass.

In some cases, one or more flow restrictors 908 are provided to reduce the sodium flow into the bypass. In some cases, sodium flow into the bypass may cause vibration and fluid velocities into the bypass that are undesirable. The flow restrictor 908 may be used to increase the pressure drop across the bypass, thereby reducing the flow rate. In some cases, the flow restrictor 908 may be welded to the bypass pipe.

As with any of the embodiments described herein, the instrument assembly 302 may be removed as a module from the reactor vessel, such as by withdrawing the entire instrument assembly 302 upward through the reactor head 208 or through the PSP flange 802. The bypass tank may remain permanently installed and provide a conduit for the instrument assembly 302 to be inserted and withdrawn. In some cases, the instrument assembly 302 includes a push on seal that mates with the bypass pipe to allow simple connection and disconnection from the bypass pipe. In some examples, the instrument assemblies can be replaced while the reactor is operating, such as in a low power state. For example, during a refueling operation, one or more instrument assemblies may be withdrawn from the reactor vessel and replaced with another instrument assembly.

In particular, sodium pressure sensors, such as a diaphragm type with NaK capillary transducers include mechanical mechanisms on the diaphragm that tend to lose accuracy over time, such as due to stress, fatigue, creep, relaxing, etc.. These sensors require regular recalibration, such as by connecting the pressure sensor to a known source of pressure, which is typically done through isolation valves and/or valve tents. However, in-situ calibration is difficult, or impossible in some cases, and therefore, sensors are typically removed and replaced with pre-calibrated pressure sensors. In some cases, the sensors need to be replaced every year, or every other year, or in some cases, every three years. In any event, sensor replacement is typically a difficult process and often requires the reactor to be shut down. In some embodiments described herein, the instrument assembly module may be removed and replaced entirely. The instrument assembly module is a module containing various sensors and is close to twelve feet long or longer, which requires an overhead crane to remove, along with a sodium cask to contain the module, and significant down time of the reactor. In fact, it is unlikely that the removal and replacement of the instrument assembly module could be accomplished during a normal shutdown duration and would require additional reactor shut down time in order to fully replace the instrument assembly module.

In some cases, pressure sensors may be used within an intermediate heat transport loop and the sensors suffer from the same drawbacks as ones installed within the reactor vessel. Historically, replacing a sensor within a heat transport loop required cutting of the metal piping and/or nozzles, and welding on replacement assemblies. Calibration of these sensors would also typically require draining any fluid from the intermediate heat transport loop and pressurizing the system with an inert gas, such as argon, in order to calibrate a new sensor.

To alleviate some of these problems, the following embodiments disclose a a flow module that is separable from the pressure sensor assembly. In some cases, the pressure sensor assembly includes two diaphragms stacked vertically with flow holes in between to allow for sodium to be exchanged in the top diaphragm which measures sodium pressure. A pressure well may be a section of pipe, such as a three-foot section of pipe with NaK capillary tubing running inside the pressure well to two corresponding transducers, which convert eh mechanical-fluid forces from the diaphragms and capillaries to electronic signals transmitted out via wiring which exit at the top of the pressure well through an electrical penetration assembly.

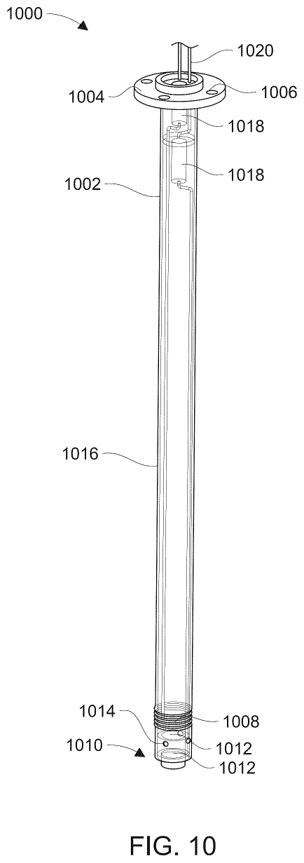

FIG. 10 illustrates a pressure sensor assembly 1000, in accordance with some embodiments, and configured for insertion into a nuclear reactor vessel through a penetration in the reactor head. In some cases, the pressure sensor assembly 1000 is removable and has redundant pressure sensors. It may also include shielding and insulation between the diaphragms and transducers to protect the transducers from the heat of the coolant. The assembly may be a sealed assembly, and may be welded together. It may also be calibrated well before insertion into a nuclear reactor. The modularity of the assembly allows it to be inserted or removed quickly and efficiently, such as during a scheduled down-time of the nuclear reactor, such as a refueling operation.

The pressure sensor assembly 1000 includes a length of pipe 1002, which may be on the order of two feet, three feet, four feet, five feet, or six feet long or longer. The pipe can be any suitable diameter, and in some cases has a diameter on the order of 0.5 in (13 mm), or 1 in (25 mm), or 1.5 in (38 mm), or 2 in (51 mm), or 3 in (76 mm), or 4 in (102 mm) or more. A pressure sensor assembly flange 1004 is coupled to an upper end of the pipe 1002 and seals the upper end of the pipe 1002. The flange 1004 may have mounting holes 1006 that allow the flange 1004 to be securely coupled to a portion of a reactor head (not shown). The pressure sensor assembly 1000 has a lower seal 1008 that seals the exterior of the pipe 1002 against a flow module. Near a lower end 1010 of the pipe 1002 are one or more pressure-responsive elements 1012, which are diaphragms 1012, in some cases. In the illustrated embodiment, two diaphragms 1012 are disposed near the lower end 1010 of the pipe 1002.

One or more flow holes 1014 may be formed near the lower end to allow sodium to enter the pipe 1002 and interact with the diaphragms 1012. The pipe is generally hollow in order to carry the transducers, and once assembled, is sealed. Capillaries, such as NaK capillaries 1016 may be formed within the pipe 1002 to allow the pressure imparted on the diaphragms 1012 to be transferred to the transducers 1018. The diaphragms 1012 may be coupled to one or more transducers 1018 located near the upper end of the pipe 1002 and the flange 1004. The diaphragms 1012 are thin, flexible membranes and may be made of metal, such as stainless steel or other suitable metals. They provide a fill fluid through which the pressure is transmitted from the diaphragm to the transducer. When the diaphragms 1012 are exposed to the coolant, the pressure of the coolant exerts a force on the diaphragm 1012, causing it to deform. The degree of deformation is proportional to the pressure applied by the fluid. The deformed diaphragm, in turn, applies pressure to the fill fluid in the capillaries 1016. The pressure in the fill fluid of the capillaries applies its pressure to the transducers 1018. The transducers 1018, in some cases, have a strain gauge that is deformed by the pressure of the fill fluid in the capillaries, thus causing the strain gauge to determine a degree of deformation, which correlates into a pressure of the primary coolant fluid. In some cases, the transducer converts the mechanical deformation of the diaphragm into an electrical signal, which may be done by any suitable technology, including, but not limited to strain gauges; capacitive sensors, piezoelectric sensors, piezoresistive sensors, and others.

The electronic signals from the transducers are transmitted out of the pressure sensor assembly 1000 by wires 1020 that exit at the top through an electric penetration assembly.

The lower seal 1008 mates with a flow module, as described elsewhere herein, and minimizes the exchange of cover gas or sodium in the space between the pressure well and the flow module. The lower seal 1008 may be any suitable type of seal, including a ring seal, an O-ring seal, a compression seal, a lip seal, a packing seal, a threaded or tapered seal, The lower seal 1008 is optional in some cases and may not be necessary with the guard pipe, as described.

The flow module, as previously described, is a reactor head mounted removable component which the pressure sensor assembly 1000 fits inside. The described pressure sensor assembly 1000 can be used with any of the flow module embodiments described herein.

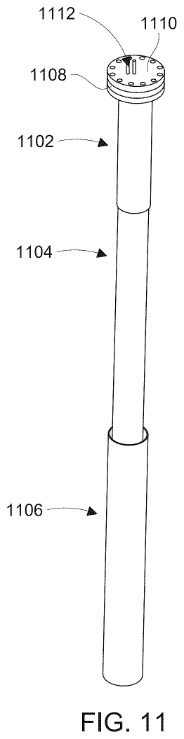

FIG. 11 illustrates an installed pressure sensor assembly into the cooperating structures and system. For instance, the reactor head include a reactor head nozzle 1102 that provides a space and support for a flow module 1104. As described herein, the flow module 1104 may be any suitable instrument module as described throughout this disclosure, but as used in relation to FIG. 11, the instrument module is configured as a flow module because of the instruments used therein to measure a flow and/or a pressure of the flowing fluid.

The flow module 1104 may inserted into the reactor head nozzle 1102 from the top, through a penetration through the reactor head. The flow module 1104 may be inserted downwardly into the reactor vessel and into a bypass tank 1106. As described elsewhere herein, the flow module receives a portion of bypass flow from the primary sodium pump and directs the bypass flow of sodium into the bypass tank, into the flow module and to the instruments contained therein. The pressure sensor assembly may be located inside the flow module 1104 as described herein.

The flow module 1104 may have a flow module flange 1108 that contacts the reactor head nozzle 1102 and provides a fluid tight seal therewith. A cover plate 1110 may be secured to an upper portion of the flow module flange 1108 to provide a fluid tight seal therewith, and may include an electric penetration assembly 1112 to allow wires from the transducers to exit the pressure sensor assembly. This arrangement, in some cases, allows the drywell portion (e.g., the pipe 1002) of the flow module and cover plate as ASME BPVC Section III primary coolant pressure boundary components, with the pressure sensor assembly being classified as instrumentation.

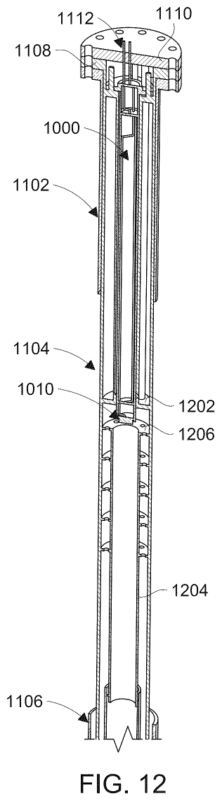

FIG. 12 illustrates a cutaway view of the components shown in FIG. 11. Specifically, the pressure sensor assembly 1000 is shown disposed within the flow module 1104. The reactor head nozzle 1102 creates a perforation through the reactor head into which the flow module 1104 can be inserted. The flow module 1104 extends downward and fits within the bypass tank 1106. The pressure sensor assembly 1000 is inserted into the flow module 1104 until an upper flange of the pressure sensor assembly 1000 seats against a shelf in the flow module and the lower end 1010 of the pressure sensor assembly 1000 fits through a boundary plate 1202 in the flow module.

A lower section of the flow module 1104 includes the flow module bypass 1204, which allows primary coolant that flows into the bypass pipe 206 to flow upwardly into the flow module bypass 1204, up to the lower end 1010 of the pressure sensor assembly 1000 where it impinges on the diaphragms of the pressure sensor assembly 1000. The primary coolant is impeded by the boundary plate 1202 and returns downwardly through the annular space in the flow module 1104, through one or more annular flow restriction plates 1206 and to through the bypass tank and back to the primary coolant inventory. The annular flow restriction plates 1206 may be provided to restrict flow and allow the coolant pressure to equalize within the flow module. The annular flow restriction plates 1206 may progressively step down the pressure without excessive velocities and pressure change, and may prevent cavitation. The annular flow restriction plates 1206 also control the flow through the bypass to prevent excessive flow from being diverted from the core. It should be noted that the boundary plate 1202 separates the lower section of the flow module 1104, which is wetted with primary coolant, from the upper section of the flow module 1104 that remains dry from the primary coolant. In some cases, the temperature of the boundary plate 1202 is measured through suitable instrumentation and can be used to determine the temperature of the bypass flow through the flow module.

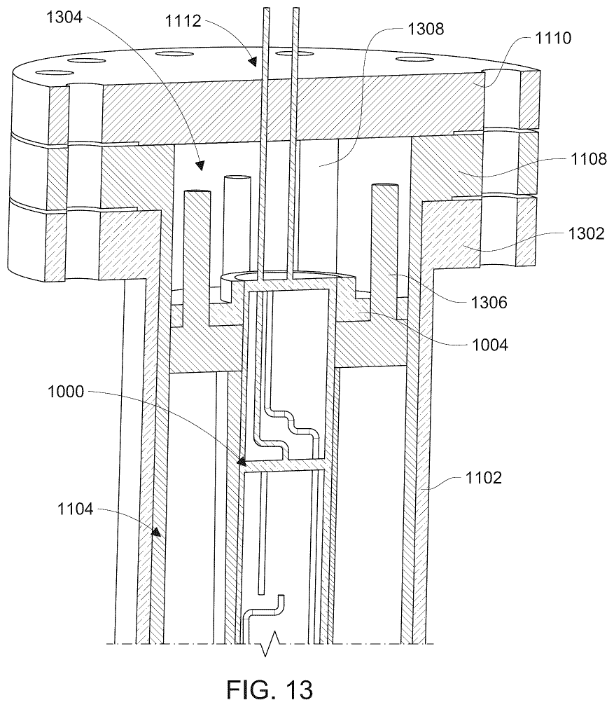

FIG. 13 is a cutaway close-up view of the upper end of the flow module 1104, pressure sensor assembly 1000, and reactor head nozzle 1102, in accordance with some embodiments. A reactor head nozzle flange 1302 provides a connection point for the reactor head nozzle 1102 to a reactor head. It may further provide a series of holes for securing the additional components to the reactor head, such as by using bolts. The reactor head nozzle flange 1302 provides a support for the flow module flange 1108. In some cases, a gasket may be provided between the flow module flange 1108 and the reactor head nozzle flange 1302 to encourage a tight seal therebetween. The flow module flange 1108, in turn, provides a support for the cover plate 1110 and electric penetration assembly 1112 that allows wires to pass through the cover plate to allow electrical communication between the transducers and equipment located outside the reactor vessel.

In some cases, the flow module 1104 provides a seal space 1304 which may be configured with leak detection equipment to detect primary coolant leaks into the seal space.

In some cases, the flow module 1104 has one or threaded studs 1306 onto which the pressure sensor flange 1004 can fit over. For example, the pressure sensor flange 1004 may have holes that allow the pressure sensor flange 1004 to fit over the threaded studs 1306 and be secured, such as by nuts. In some cases, a series of holes are formed in the cover plate 1110, the flow module flange 1108, and the reactor head nozzle flange 1302 that cooperate to allow the components to be secured together. For instance, the reactor head nozzle flange 1302 may include a plurality of tapped holes and the flow module flange 1108 and cover plate 1100 may have through holes that align to allow a bolt to pass downwardly through the cover plate 1110 and the flow module flange 1108 to be secured within the tapped holes of the reactor head nozzle flange 1302. In some cases, one or more gaskets may be placed in between each of these components to encourage a seal therebetween.

In some embodiments, a thermowell 1308 may be provided that allows temperature sensing instruments to be housed therein and may extend from the cover plate 1110 down to the boundary plate 1202 of the flow module 1104 to determine the temperature of the boundary plate, and the concomitant temperature of the primary coolant.

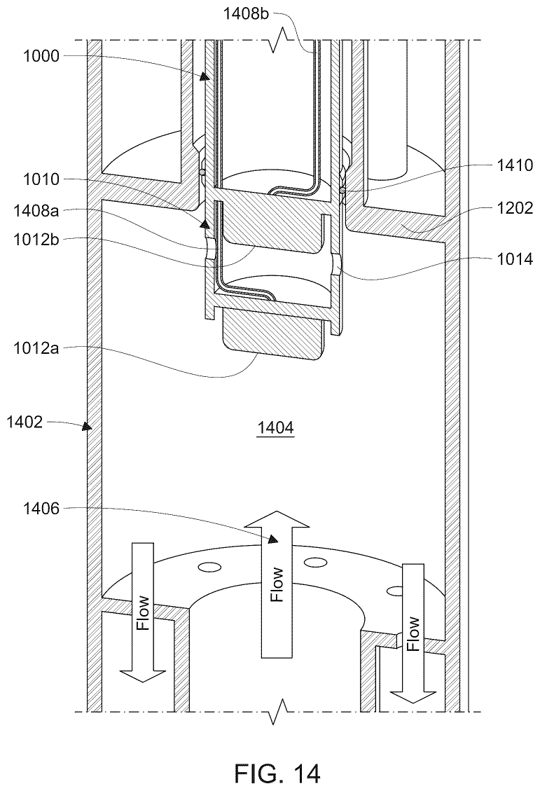

FIG. 14 illustrates a close-up cutaway view the lower end 1010 of the pressure sensor assembly 1000, in accordance with some embodiments. The lower end 1010 of the pressure sensor assembly 1000 may include one, two, or more diaphragms 1012a, b that react to pressure from primary coolant flowing inside the flow module return pipe 1402. The lower diaphragm 1012a is exposed within the flow module return pipe 1402 to primary coolant flow that enters the pressure chamber 1404 therein, shown by arrow 1406. As primary coolant enters the pressure chamber 1404, it impinges upon the lower diaphragm 1012a which deforms in response to the pressure of the fluid. The lower end 1010 of the pressure sensor assembly 1000 includes flow holes 1014, that allow primary coolant to enter the lower end and impinge upon an upper diaphragm 1012b which deforms in response to the fluid pressure. The primary coolant that enters the pressure chamber 1404 also comes into contact with the boundary plate 1202 and heats the boundary plate 1202. The thermowell 1308 allows a temperature measuring device, such as a thermocouple, to measure the temperature of the boundary plate 1202, and likewise, the temperature of the primary coolant in the pressure chamber 1404. Each of the diaphragms 1012a, b are coupled to the capillary tubes 1408a, 1408b that may include NaK and the capillary tubes 1408a, 1408b couple the diaphragms 102a, b to the transducers located remotely from the heat of the primary coolant. The diaphragms 1012 can be formed of any suitable material, and in some examples, is 316L stainless steel, Inconel 625, Hastelloy C-276, and/or other corrosion-resistant alloys. Each diaphragm 1012 can have a thickness ranging from about 0.1 mm to about 2 mm, or from about 0.3 mm to about 1 mm, or about 0.5 mm. The diaphragms 1012 can have a circular shape, an elliptical shape, and/or a polygonal shape.

As the primary coolant enters the pressure chamber 1404, it may also impinge upon the boundary plate 1202 and turn downwardly to flow through the annular flow restriction plate 1206 and eventually, out of the pressure module and back into the primary coolant inventory within the reactor vessel. The flow module 1104 may be thought of as separated into 2 parts, a lower part that is wetted by the primary coolant below the boundary plate 1202 and a dry well above the boundary plate 1202 that houses the instrumentation and wiring. The pressure sensor assembly 1000 may extend beyond the boundary plate 1202 such that its lower end is in communication with the pressure chamber 1404 and the diaphragms therein become wetted and deformed in response to the pressure from the primary coolant in the pressure chamber 1404. The pressure sensor assembly 1000 may seal against the opening in the boundary plate 1202, such as by one or more seals 1410 to inhibit primary coolant from getting past the boundary plate 1202 and entering the drywell portion of the flow module 1104.

The entire pressure sensor assembly 1000 can easily and quickly be replaced, when necessary. For example, during a period of reactor shutdown when the primary coolant pump is shut down or operating at a reduced flow state, the bolts can be removed from the cover plate, which can be removed from over the flow module 1104, which exposes an upper surface of the pressure sensor assembly 1000. The pressure sensor assembly 1000 can then be removed from its attachment to the flow module 1104, such as be removing nuts securing the components together. The pressure sensor assembly 1000 may then be lifted vertically out of the flow module 1104 and replaced with a new pressure sensor assembly 1000 that has been precalibrated. The replacement of the pressure sensor assembly 1000 may be performed without removing the reactor coolant pump, which is a novel advantage of many embodiments described herein. With the size of the pressure sensor assembly 1000, it may be removed by hand, by a small lift, and may not need a gantry crane in order to remove the pressure measuring equipment, as in prior cases. In some instances, remote equipment may be used due to the radiological environment. As described herein, the pressure sensor assembly 1000 may comprise a tube of about 3 feet long, and a diameter of about 2 inches, which is the entirety of the pressure sensor assembly, which makes replacement efficient as opposed to prior systems and methods.

In some embodiments, the transducers of the pressure sensor assembly 1000 may be further removed from the primary coolant, such as by disposing the transducers above the reactor head and reactor head nozzle.

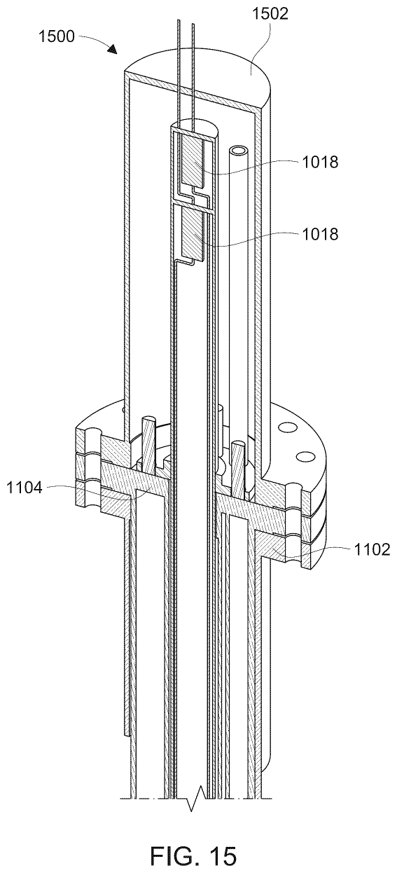

FIG. 15 illustrates another embodiment of a pressure sensor assembly 1500 in accordance with some embodiments. One of the issues with sensitive equipment, especially in a nuclear reactor environment, is exposure to heat and to some degree, radioactivity. The incorporation of a guard pipe can further remove the sensitive transducers from the thermal energy and the activated primary coolant.

As shown, a guard pipe 1502 can be used to provide a vertical space above the reactor head nozzle 1102 so the transducers 1018 can be located further away from the boundary plate 1202.

In the illustrated embodiment, the reactor head nozzle 1102 and the flow module 1104 may be formed as described with respect to other embodiments herein. One of the primary differences is that, with the incorporation of the guard pipe 1502 that provides an enclosed space above the reactor head, the pressure sensor assembly 1500 can be modified so that the pressure sensor assembly flange 1004 can be located nearer the middle of the pressure sensor assembly 1500 rather than at an upper end. Therefore, as the pressure sensor assembly flange 1004 is coupled to the flow module, as previously described, the transducers 1018 are located above the pressure sensor assembly flange 1004 and into the guard pipe 1502. In practice, the guard pipe 1502 replaces the cover plate of other embodiments and provides a vertical enclosed space above the flow module 1104 to located the upper end of the pressure sensor assembly 1500. In other words, the pressure sensor assembly 1500 has a first upper end and a second lower end. One or more diaphragms are located near the second lower end and are positioned to bed in physical contact with primary coolant of the nuclear reactor. One or more transducers 1018 may be located near the upper end of the pressure sensor assembly 1500 and are above the pressure sensor assembly flange 1004.

The guard pipe 1502 may couple to the flow module 1104 and the reactor head nozzle 1102 as previously described, and one or more gaskets may be located between the surfaces of the components to encourage a tight seal. The guard pipe 1502 may include an electric penetration assembly to allow electrical wire to exit the guard pipe 1502 so electrical signals from the transducers can be sent to other equipment outside the guard pipe 1502. The guard pipe 1502 achieves better separation of the transducers in the pressure well from flow module nozzle which provides a less demanding thermal and radiological environment.

In some cases, leak detection equipment can be provided within the guard pipe.

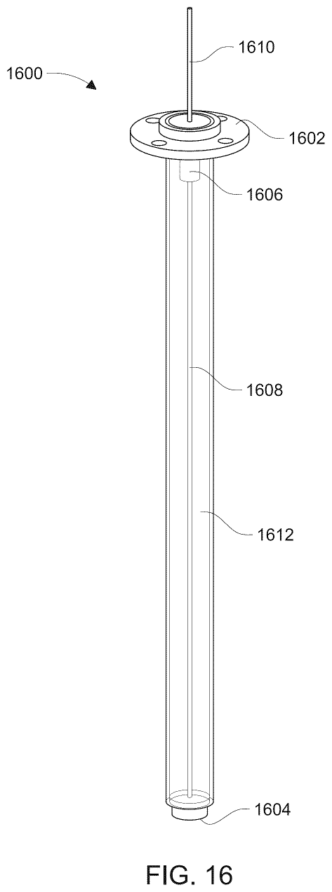

FIG. 16 illustrates another embodiment of a pressure sensor assembly 1600, in accordance with some embodiments. In particular, the illustrated embodiment may be used in conjunction with another heat transport loop, such as a pipe configured to convey thermal energy media. In some cases, the heat transport loop may be a pipe carrying a fluid, such as any suitable heat transfer fluid.

The pressure sensor assembly 1600 may have a flange 1602 near an upper end and a diaphragm 1604 near a lower end. The diaphragm 1604 may be in communication with a transducer 1606, by fill fluid in the capillary tube 1608. The assembly may be coupled together by any suitable connection, such as bolts, press fit, welding, swaging or otherwise. The transducer 1606 is contained within a pressure well 1612, that may be a pipe, formed of any suitable material, such as stainless steel, ferritic-martensitic steel, HT9, or otherwise. In some examples, the pressure well is a sealed, hollow pipe, and may be filled with insulation, radiation shielding, leak detection sensors, or a combination. Wires 1610 may penetrate through the upper end to allow the transducer 1606 to communicate with equipment outside the pressure sensor assembly 1600. The pressure sensor assembly 1600 may be a sealed assembly that can be easily replaced for another assembly, as required.

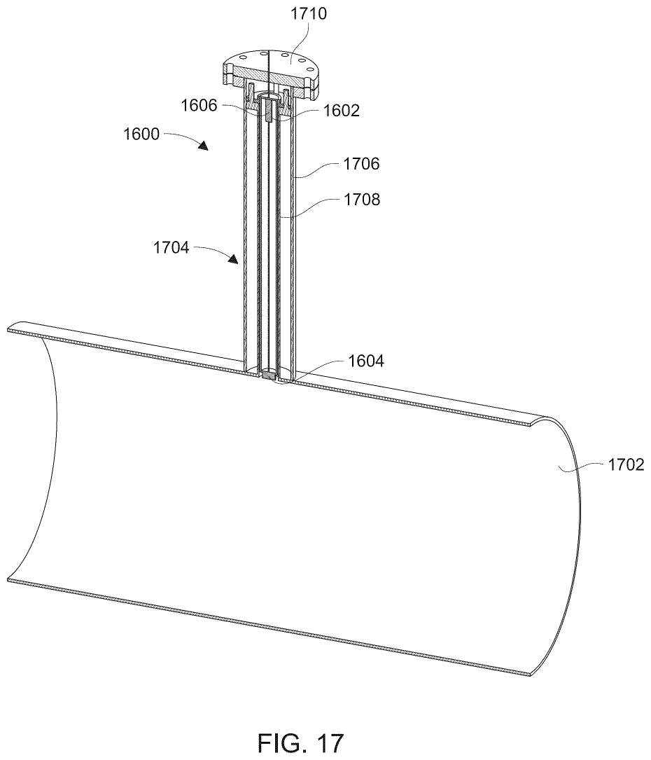

FIG. 17 illustrates the pressure sensor assembly 1600 installed into a fluid loop, in accordance with some embodiments. The fluid loop may contain a pipe 1702 of suitable diameter and suitable material. The pipe 1702 may have a standoff 1704 extending therefrom that comprises an outer nozzle 1706 and an inner nozzle 1708 and an annular space in between. The pressure sensor assembly 1600 fits inside the inner nozzle 1708 and the flange 1602 cooperates with the inner nozzle 1708 to properly locate the pressure sensor assembly 1600 within the standoff 1704.

The top of the standoff 1704 may be covered with a cover plate 1710 that seals the standoff 1704 from potential coolant leaks. The lower end of the pressure sensor assembly 1600 may pass through a penetration in the pipe 1702 so the diaphragm 1604 interacts with the coolant flowing in the pipe 1702 to be deflected by the fluid pressure in the pipe 1702. The deflection of the diaphragm 1604 is transmitted to the transducer 1606 which generates a signal associated with the deformation of the diaphragm 1604 that correlates to the fluid pressure in the pipe 1702. In some cases, the annular space between the outer nozzle 1706 and the inner nozzle 1708 may include insulation, shielding, an inert gas, leak detection sensors, or a combination.

In use, the pressure sensor assembly 1600 is preferably calibrated before insertion in the standoff 1704. When the pressure sensor assembly 1600 is replaced, the pumps that drive the coolant through the pipe 1702 may be shut off, the loop may be drained, the cover plate 1710 can be removed and the pressure sensor assembly 1600 can be quickly swapped out for a new, calibrated, one. Alternatively, the replacement of the pressure sensor assembly 1600 may be performed by pressurizing the inner nozzle 1708, such as with an inert gas (e.g., argon) and the pressure sensor assembly 1600 can be replaced without shutting down the coolant pumps or draining the pipe 1702.

The pressure sensor assembly 1600 in the illustrated embodiments may share components and features with other embodiments described herein, including, but not limited to, electrical penetrations, a seal space which may include coolant leak detection equipment, gaskets, and others. In some cases, the embodiments that show the pressure sensor assembly inserted through the reactor head nozzle may be interchanged with embodiments shown inserted through a pipe standoff in a coolant loop.

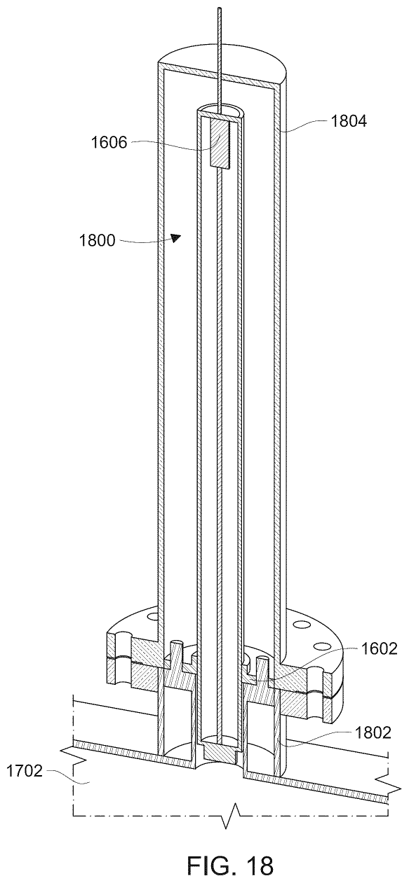

FIG. 18 illustrates an embodiment of a pressure sensor assembly 1800 inserted into a pipe standoff 1802 that incorporates a guard pipe 1804. Similar to other embodiments described herein, the guard pipe 1804 provides space above the standoff 1802 to locate the transducer 1606 further away from the thermal and radiological environment of the coolant flowing in the pipe 1702. The provides further protection for the transducer 1606. The flange 1602 may be located lower on the pressure sensor assembly 1800, and in some cases, the flange 1602 is located between the diaphragm 1604 and the transducer 1606.

According to some embodiments, a pressure sensor assembly is provided for measuring pressure of coolant in a reactor, which includes a hollow pipe having a first end and a second end; at least one pressure-responsive element near the second end; at least one signal conversion element coupled to the at least one pressure-responsive element; and a mounting structure configured to couple the hollow pipe to a reactor structure.

While the illustrated embodiments show diaphragms 1012 as the pressure-responsive elements, the pressure sensor assembly 1000 can alternatively or additionally employ other pressure-responsive elements 1012 suitable for liquid sodium service. The pressure-responsive element 1012 can comprise a welded metal bellows assembly having 10 to 30 convolutions, providing enhanced sensitivity and longer stroke capability compared to flat diaphragms. The pressure-responsive element can comprise a Bourdon tube configured in a helical or spiral arrangement to increase sensitivity while maintaining compactness. The pressure-responsive element can comprise a capsule assembly formed of two corrugated diaphragms peripherally welded together, providing twice the deflection of a single diaphragm for the same pressure change. For high-temperature applications above 500° C., the pressure-responsive element can comprise a piezoresistive sensor utilizing silicon carbide (SiC) or sapphire substrates that maintain stability at elevated temperatures. The pressure-responsive element can comprise a capacitive sensor with ceramic or quartz dielectric materials compatible with the radiation environment. The pressure-responsive element can comprise an optical sensor utilizing fiber-optic technology to transmit pressure signals without electromagnetic interference concerns. The pressure-responsive element can comprise a resonant sensor whose vibration frequency shifts proportionally with pressure, providing digital output directly compatible with plant control systems. Each of these pressure-responsive elements can be configured with redundant units for enhanced reliability and can be pre-calibrated before installation in the pressure sensor assembly 1000.

The pressure-responsive element 1012 can comprise a bellows assembly which may be formed of AM350 stainless steel, Inconel 718, and/or Inconel X-750. The bellows assembly can have a convolution count ranging from 5 to 50, or from 10 to 30, or about 20 convolutions. The bellows assembly can have an effective diameter ranging from about 10 mm to about 100 mm, or from about 20 mm to about 60 mm, or about 40 mm. The bellows assembly can be configured as an edge-welded bellows, a formed bellows, and/or an electroformed bellows.

The pressure-responsive element 1012 can comprise a Bourdon tube having a C-shaped configuration, a helical configuration, and/or a spiral configuration. The Bourdon tube can be formed of Monel 400, Inconel 625, and/or 316L stainless steel. The Bourdon tube can have a wall thickness ranging from about 0.5 mm to about 5 mm, or from about 1 mm to about 3 mm, or about 2 mm. The Bourdon tube can have an oval cross-section with a major axis to minor axis ratio ranging from about 1.5:1 to about 3:1.

The pressure-responsive element 1012 can comprise a capsule element formed of two corrugated diaphragms welded together at their periphery. The capsule element can have a diameter ranging from about 25 mm to about 150 mm, or from about 50 mm to about 100 mm, or about 75 mm. The corrugations can have a depth ranging from about 0.5 mm to about 5 mm and a pitch ranging from about 2 mm to about 10 mm.

The pressure-responsive element 1012 can comprise a piezoresistive sensor having a silicon carbide (SiC) sensing element, a sapphire sensing element, and/or a silicon-on-insulator (SOI) sensing element configured to operate at temperatures up to 600° C. The piezoresistive sensor can include a Wheatstone bridge configuration with four active strain gauges arranged on a diaphragm substrate.

The pressure-responsive element 1012 can comprise a capacitive pressure sensor having a fixed electrode and a movable electrode separated by a gap ranging from about 10 micrometers to about 500 micrometers. The movable electrode can be integrated with a metal diaphragm, a ceramic diaphragm, and/or a quartz diaphragm. The capacitive sensor can utilize a differential capacitance measurement configuration to compensate for temperature effects.

The pressure-responsive element 1012 can comprise an optical pressure sensor utilizing a Fabry-Pérot interferometer configuration. The optical sensor can include a pressure-sensitive cavity formed between two partially reflective surfaces, with cavity length changes detected through optical interference patterns. The optical sensor can employ sapphire windows and/or fused silica components rated for high-temperature sodium service.

The pressure-responsive element 1012 can comprise a resonant pressure sensor having a vibrating element whose resonant frequency changes with applied pressure. The vibrating element can be a quartz crystal, a silicon microbeam, and/or a metallic resonator. The resonant sensor can operate at frequencies ranging from about 10 kHz to about 100 kHz, with frequency shifts of about 10 Hz to about 1000 Hz per psi of applied pressure.

According to some embodiments, a method of measuring coolant pressure in a nuclear reactor includes the steps of inserting a pressure sensor assembly through a penetration in a reactor head; coupling a pressure-responsive element to a coolant flow path; transmitting pressure from the pressure-responsive element to a signal converter; converting the pressure to an electrical signal; and transmitting the electrical signal to monitoring equipment outside the reactor.

In some cases, the method can include the steps of calibrating the pressure sensor assembly prior to the inserting step; and verifying calibration of the pressure sensor assembly after the coupling step using a reference pressure source. The inserting step can include lifting the pressure sensor assembly using a crane attachment point on a mounting flange; aligning the pressure sensor assembly with guide pins in the penetration; and lowering the pressure sensor assembly until the mounting flange contacts a reactor head nozzle.

In some cases, the coupling step includes engaging a slip-on coupling at a lower end of the pressure sensor assembly with a bypass pipe; compressing one or more annular sealing ridges between the slip-on coupling and the bypass pipe; and establishing a metal-to-metal seal rated for sodium service at temperatures ranging from 200° C. to 550° C.

The method can further include the steps of monitoring a sodium level in a bypass tank using a first pressure measurement during reactor operation below 20% power; and switching to a second pressure measurement during reactor operation above 20% power.

The transmitting pressure step can include transmitting pressure through a sodium-potassium (NaK) filled capillary tube having a length ranging from 0.5 meters to 3 meters; and maintaining the NaK in a liquid state at operating temperatures ranging from 200° C. to 550° C.

The method can further include measuring pressure using at least two pressure-responsive elements; comparing signals from the at least two pressure-responsive elements; and generating a fault signal when the signals differ by more than a predetermined threshold.

In some examples, the predetermined threshold is 2% of full-scale pressure.

The method can include the steps of isolating a low-range pressure sensor when coolant pressure exceeds a threshold pressure; and activating a high-range pressure sensor when the coolant pressure exceeds the threshold pressure. The threshold pressure can correspond to reactor operation at 20% power.

Some examples further include detecting a leak in a seal space between the pressure sensor assembly and a flow module using conductivity sensors; and generating an alarm signal when sodium is detected in the seal space.

In some cases, the converting step includes deforming a diaphragm in response to coolant pressure; changing resistance in a strain gauge bonded to the diaphragm; and generating a current signal proportional to the coolant pressure.

The method may further include measuring temperature at a boundary plate using a thermocouple in a thermowell; compensating the electrical signal based on the measured temperature; and calculating actual coolant pressure corrected for thermal effects.

Some examples include removing the pressure sensor assembly during a reactor refueling outage without removing a primary sodium pump; wherein the removing may be completed in less than 4 hours.

In some instances, the method includes installing a replacement pressure sensor assembly that has been pre-calibrated; and verifying proper installation by comparing pressure readings with adjacent pressure sensors.

The pressure sensor assembly may include a guard pipe extending above the reactor head, and the method may further include positioning the signal converter within the guard pipe at least 1 meter above the reactor head; and maintaining temperature of the signal converter below 100° C. using thermal insulation in the guard pipe. Some examples include the step of continuously monitoring pressure during reactor operation from 5% to 100% of full power; recording pressure data at a sampling rate of at least 10 Hz; and transmitting the pressure data to a plant control system for flow rate calculation.

In some examples, the coolant flow path comprises a bypass pipe diverting less than about 2% of total flow from a primary sodium pump discharge.

Optional steps include priming the coolant flow path with sodium by gradually increasing pump flow; establishing a siphon in a bypass pipe to maintain sodium level; and maintaining sodium contact with the pressure-responsive element during low-flow conditions below 20% of rated flow.

Other optional steps include providing redundant pressure measurements using a first pressure sensor assembly and a second pressure sensor assembly; wherein the first and second pressure sensor assemblies are installed in separate bypass tanks; and wherein each pressure sensor assembly can be individually removed without affecting operation of the other.

Some examples include the steps of performing in-situ verification of pressure measurement accuracy by: measuring differential pressure across a known flow restriction; calculating expected pressure based on measured flow rate; and adjusting calibration factors when measured pressure deviates from expected pressure, such as by more than 1%.

The pressure-responsive element may include an optical pressure sensor, and wherein the transmitting pressure step includes transmitting optical signals through a fiber optic cable rated for radiation exposure of at least 10\hat{ }8 rads; and maintaining optical signal integrity at temperatures up to 550° C.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments, but should be defined only in accordance with the following claims and their equivalents.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

Unless otherwise noted, the terms “connected to” and “coupled to” (and their derivatives), as used in the specification, are to be construed as permitting both direct and indirect (i.e., via other elements or components) connection. In addition, the terms “a” or “an,” as used in the specification, are to be construed as meaning “at least one of.” Finally, for ease of use, the terms “including” and “having” (and their derivatives), as used in the

The specification and annexed drawings disclose examples of systems, apparatus, devices, and techniques that may provide control and optimization of coolant flow through core assemblies. It is, of course, not possible to describe every conceivable combination of elements and/or methods for purposes of describing the various features of the disclosure, but those of ordinary skill in the art recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein. Examples put forward in the specification and annexed drawings should be considered, in all respects, as illustrative and not restrictive. Although specific terms are employed herein, they are used in a generic and descriptive sense only, and not used for purposes of limitation.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The methods described in relation 0embodiments herein may be implemented by one or more processors executing instructions that cause the processors to carry out the disclosed methods.

Throughout the instant specification, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A pressure sensor assembly for measuring pressure of primary sodium coolant in a sodium fast reactor, comprising:
a sealed hollow pipe having a first end and a second end;
one or more diaphragms near the second end;
a transducer within the sealed hollow pipe near the first end;
a capillary tube coupling the one or more diaphragms and the transducer; and
a mounting flange configured to mount the sealed hollow pipe to a reactor head of a nuclear reactor.

2. The pressure sensor assembly as in claim 1, wherein the mounting flange is located at the first end and seals the first end.

3. The pressure sensor assembly as in claim 1, further comprising an electrical penetration through the mounting flange configured to allow wires to extend from the transducer to a location outside the pressure sensor assembly.

4. The pressure sensor assembly as in claim 1, wherein the sealed hollow pipe is filled with insulation, radiation shielding, or a combination.

5. The pressure sensor assembly as in claim 1, further comprising a ring seal on an outside surface of the sealed hollow pipe and configured to cooperate with a bypass tank located within a nuclear reactor vessel to provide a fluid tight seal between the tube and the bypass tank.

6. The pressure sensor assembly as in claim 1, wherein the mounting flange is located along the sealed hollow pipe at an intermediate location in between the transducer near the first end and the one or more diaphragms near the second end.

7. The pressure sensor assembly as in claim 1, wherein the one or more diaphragms comprise two diaphragms vertically stacked with flow holes positioned therebetween to allow sodium exchange.

8. The pressure sensor assembly as in claim 1, further comprising:
a first pressure sensor configured for low-range pressure measurements at reactor power up to a threshold power level; and
a second pressure sensor configured for high-range pressure measurements at reactor power greater than the threshold power level.

9. A sensor system for a sodium-cooled reactor, comprising:
a bypass pipe fluidly coupled to a reactor primary sodium pump discharge;
a bypass tank positioned above a reactor core and coupled to the bypass pipe;
at least one instrument module removably positioned in the bypass tank through an aperture in a reactor head, the instrument module comprising:
a pressure sensor assembly including one or more diaphragms configured to interact with sodium coolant and a transducer configured to convert pressure to an electrical signal; and
wherein the instrument module is accessible for maintenance or replacement operations through the reactor head.

10. The sensor system as in claim 9, wherein the instrument module is configured to measure one or more of pressure, temperature, and flow rate of the sodium coolant.

11. The sensor system as in claim 9, further comprising a mounting flange for each instrument module to facilitate secured mounting and removal through the reactor head.

12. The sensor system as in claim 9, wherein the bypass tank comprises access apertures aligned with corresponding reactor head openings to facilitate direct access to the instrument modules.

13. The sensor system as in claim 9, wherein the bypass tank is positioned within a primary sodium pump tank.

14. The sensor system as in claim 9, wherein the at least one instrument module comprises a slip-on coupling configured to form a removable fluid-tight seal with the bypass pipe.

15. The sensor system as in claim 9, wherein the instrument module comprises:
a flow module bypass configured to receive sodium from the bypass pipe;
a boundary plate separating a wetted lower section from a dry upper section of the instrument module; and
one or more annular flow restriction plates configured to control pressure drop through the instrument module.

16. A modular pressure sensor for a sodium-cooled reactor, comprising:
a pressure assembly having one or more diaphragms configured to contact sodium coolant;
a capillary tube configured to transmit pressure from the one or more diaphragms;
a transducer configured to convert pressure transmitted through the capillary tube into an electrical signal;
a guard pipe extending above a reactor vessel head, the guard pipe configured to house the transducer outside of a thermal and radiological environment of the sodium coolant; and
a flange configured to enable replacement of the pressure assembly through a reactor head.

17. The modular pressure sensor as in claim 16, wherein the guard pipe is configured to house additional instrumentation for leak detection in its sealed space.

18. The modular pressure sensor as in claim 16, wherein the flange is positioned to align with existing reactor head structures, facilitating quick detachment and reattachment during replacement procedures.

19. The modular pressure sensor as in claim 16, wherein the guard pipe comprises:
a sealed interior space;
thermal insulation surrounding at least a portion of the transducer; and
radiation shielding positioned between the one or more diaphragms and the transducer.

20. The pressure sensor assembly as in claim 16, further comprising a removable cover plate attached to the guard pipe permitting maintenance and inspection of the sensor.
